(19) United States
(12) Patent Application Publication
(10) Pub. No.: US 2002/0122265 A1
(43) Pub. Date: Sep. 5, 2002

(54) CMOS DC offset correction circuit with programmable high-pass transfer function

(76) Inventors: Mark J. Chambers, Mission Viejo, CA (US); Scott A. Kaylor, Mesa, AZ (US); Jose O. Perez, Tempe, AZ (US); Alan I. Chaiken, Chandler, AZ (US)

Correspondence Address: TEXAS INSTRUMENTS INCORPORATED, P O BOX 655474, M/S 3999, DALLAS, TX, 75265

(21) Appl. No.: 09/902,051

(22) Filed: Jul. 10, 2001

Related U.S. Application Data
(60) Provisional application No. 60/217,046, filed on Jul. 10, 2000.

(51) Int. Cl. G11B 5/02

(52) U.S. Cl. 360/67; 360/25

(57) ABSTRACT

An offset correction circuit to correct DC offset in accordance with a data rate includes a detection circuit to detect a thermal asperity signal and a filter circuit to respond to the thermal asperity signal in accordance with the data rate.

### FIELD OF THE INVENTION

The present invention relates to an apparatus and circuit for compensating for thermal asperity in a data channel of, for example, a hard disk drive which has an MR (magneto-resistive) head used as a read head.

### BACKGROUND OF THE INVENTION

In the data channel for a magneto-resistive (MR) sensor to read a data signal, a transient disturbance can result from a “thermal asperity.” When a hard particle trapped on the surface of a magnetic disk collides with an MR sensor riding closely adjacent to the disk surface, a rapid temperature rise occurs in the sensor. This collision results in friction-generated temperature which can increase up to 120° C. and first occurs at the point of contact between the particle and the MR sensor. The localized temperature increase produces a small but sudden increase in temperature of the entire MR sensor, perhaps as much as several centigrade degrees averaged over the whole sensor, within 50 to 100 nanoseconds. Because the MR sensor has a non-zero temperature coefficient of resistance (e.g. 0.003/° C. for permalloy), the sensor resistance then increases in response to the sudden temperature rise.

The heat conducted into the MR sensor from the localized hot spot diffuses slowly from the sensor to the local environment, causing the typical delayed exponential decay known for such thermal asperities. FIG. 1 illustrates one such.

Because the MR sensor detects magnetic signals by exploiting the magneto-resistive effect, resistance changes arising from magnetic changes on the disk surface adjacent to the sensor are detected as changes in voltage across the sensor. A DC bias current induces the voltage across the sensor resistance that varies according to changes in the sensor resistance. Since typical signals are differential, the signals can be different with respect to each other, and, consequently, this difference is reflected as a voltage offset from each other. Because MR sensor non-linearity increases with increasing magnetic signal excursions about the sensor bias point, the sensor is designed to keep the magnetic excursions induced by desired data signals sufficiently small to ensure reasonable sensor linearity. For instance, detection of a magnetic change on the disk surface may require only a 0.3 percent change in sensor resistance. Thus, thermal asperity transients can exceed 400 percent of the typical base-to-peak magnetic data signal voltage amplitude from the MR sensor.

Thermal asperity (TA) detectors are used to detect anomalies in a disk read signal that are caused by heating of the head's magneto-resistive sensor as it strikes a disk asperity.

A portion of the read channel includes a timing recovery loop to determine the timing of the data recovered in terms of the actual data recorded. A thermal asperity can upset the timing recovery loop since data transitions are obscured by the large signal superimposed as a result of the thermal asperity. A consequence for the read channel from a thermal asperity is a poor bit error rate (BER) performance which can render the portion of the magnetic disk which includes the defect which causes the thermal asperity to be unusable. This limits the total storage capacity of the hard disk drive, and, correspondingly, it is important to recover from these thermal asperities as quickly as possible.

Additionally, once the amplitude of the data signal changes due to the thermal asperity, it cannot be correctly processed (or demodulated) in the read channel of the hard disk drive until it regains the normal level. In addition to timing problems, this imposes an adverse influence on the AGC (automatic gain control) amplifier provided in the read channel. The AGC amplifier generally includes a feedback circuit designed to maintain the data signal at a constant level. Thus, the thermal asperity renders it difficult for the read channel to reproduce data from the disk.

### SUMMARY OF THE INVENTION

The present invention provides a high-pass filter that is switched on in response to thermal asperity. This high-pass filter has a high-pass pole which tracks the data rate by tuning a transconductance element of the high-pass filter so that it is proportional to the data rate clock. This results in optimum DC offset suppression over a wide range of data rates corresponding to read back signals or the data signals distributed from the outer circumference of the magnetic disk (i.e., OD) to the inner circumference of the magnetic disk (i.e., ID). Additionally, the high-pass filter includes a separate bandwidth tuning loop that generates a tuning voltage V_{TUNE} that causes the transconductance element to track the data rate. The present invention also includes a thermal asperity suppression mode that enables the high-pass filter to transition back to the normal mode in accordance with a gradual transition (as contrasted with a sharp transition). Thus, a gradual transition from a TA mode to an OFF mode minimizes amplitude and phase disturbances in the read back signal which can degrade BER and lead to the loss of timing recovery synchronization in the timing recovery loop. The gradual transition is accomplished by an attenuation block in that the gain of the attenuation block transitions from unity to zero in accordance, for example, with a slow exponentially decaying response.

The high-pass filter additionally includes an auto-zero mode so that the internal DC offset, which results from device mismatching, is canceled. This ensures that there is no shift in the corrected DC mode offset going from the normal mode to the TA suppression mode.

### BRIEF DESCRIPTION OF THE DRAWINGS

FIG. 1 illustrates a typical TA event;

FIG. 2 illustrates a read channel block diagram in accordance with the present invention;

FIG. 3 illustrates a block diagram of the present invention;

FIG. 4 illustrates a more detailed circuit diagram of the present invention illustrated in FIG. 3;

FIG. 5 illustrates signals used in accordance with the present invention;

FIG. 6 illustrates an additional graph of V_{TUNE} signal used in accordance with the present invention;

FIG. 7 is a side view of a disk drive system; and

FIG. 8 is a top view of a disk drive system.

### DETAILED DESCRIPTION OF THE PRESENT INVENTION

The following invention is described with reference to figures in which similar or the same numbers represent the same or similar elements. While the invention is described in terms for achieving the invention's objectives, it can be appreciated by those skilled in the art that variations may be accomplished in view of these teachings without deviation from the spirit or scope of the invention.

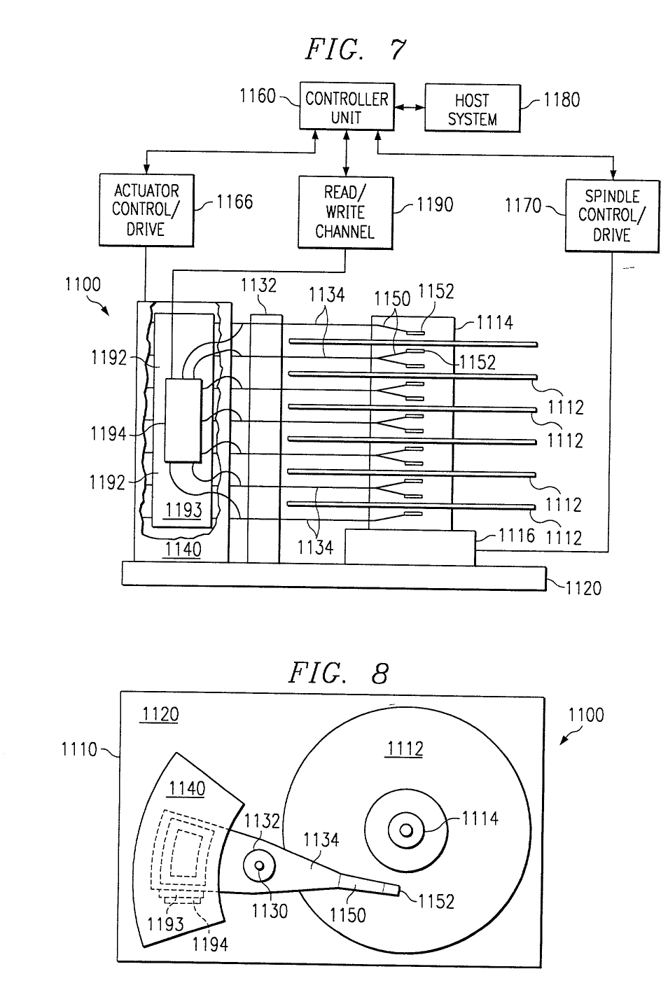

FIGS. 7 and 8 show a side and top view, respectively, of the disk drive system designated by the general reference 1100 within an enclosure 1110. The disk drive system 1100 includes a plurality of stacked magnetic recording disks 1112 mounted to a spindle 1114. The disks 1112 may be conventional particulate or thin film recording disk or, in other embodiments, they may be liquid-bearing disks. The spindle 1114 is attached to a spindle motor 1116 which rotates the spindle 1114 and disks 1112. A chassis 1120 is connected to the enclosure 1110, providing stable mechanical support for the disk drive system. The spindle motor 1116 and the actuator shaft 1130 are attached to the chassis 1120. A hub assembly 1132 rotates about the actuator shaft 1130 and supports a plurality of actuator arms 1134. The stack of actuator arms 1134 is sometimes referred to as a “comb.” A rotary voice coil motor 1140 is attached to chassis 1120 and to a rear portion of the actuator arms 1134.

A plurality of head suspension assemblies 1150 are attached to the actuator arms 1134. A plurality of inductive transducer heads 1152 are attached respectively to the suspension assemblies 1150, each head 1152 including at least one inductive write element. In addition thereto, each head 1152 may also include an inductive read element or a MR (magneto-resistive) read element. The heads 1152 are positioned proximate to the disks 1112 by the suspension assemblies 1150 so that during operation, the heads are in electromagnetic communication with the disks 1112. The rotary voice coil motor 1140 rotates the actuator arms 1134 about the actuator shaft 1130 in order to move the head suspension assemblies 1150 to the desired radial position on disks 1112.

A controller unit 1160 provides overall control to the disk drive system 1100, including rotation control of the disks 1112 and position control of the heads 1152. The controller unit 1160 typically includes (not shown) a central processing unit (CPU), a memory unit and other digital circuitry, although it should be apparent that these aspects could also be enabled as hardware logic by one skilled in the computer arts. Controller unit 1160 is connected to the actuator control/drive unit 1166 which is in turn connected to the rotary voice coil motor 1140. A host system 1180, typically a computer system or personal computer (PC), is connected to the controller unit 1160. The host system 1180 may send digital data to the controller unit 1160 to be stored on the disks, or it may request that digital data at a specified location be read from the disks 1112 and sent back to the host system 1180. A read/write channel 1190 is coupled to receive and condition read and write signals generated by the controller unit 1160 and communicate them to an arm electronics (AE) unit shown generally at 1192 through a cut-away portion of the voice coil motor 1140. The read/write channel 1190 includes the phase lock loop of the present invention. The AE unit 1192 includes a printed circuit board 1193, or a flexible carrier, mounted on the actuator arms 1134 or in close proximity thereto, and an AE module 1194 mounted on the printed circuit board 1193 or carrier that comprises circuitry preferably implemented in an integrated circuit (IC) chip including read drivers, write drivers, and associated control circuitry. The AE module 1194 is coupled via connections in the printed circuit board to the read/write channel 1190 and also to each read head and each write head in the plurality of heads 1152. The read/write channel 1190 includes the offset correction circuit of the present invention.

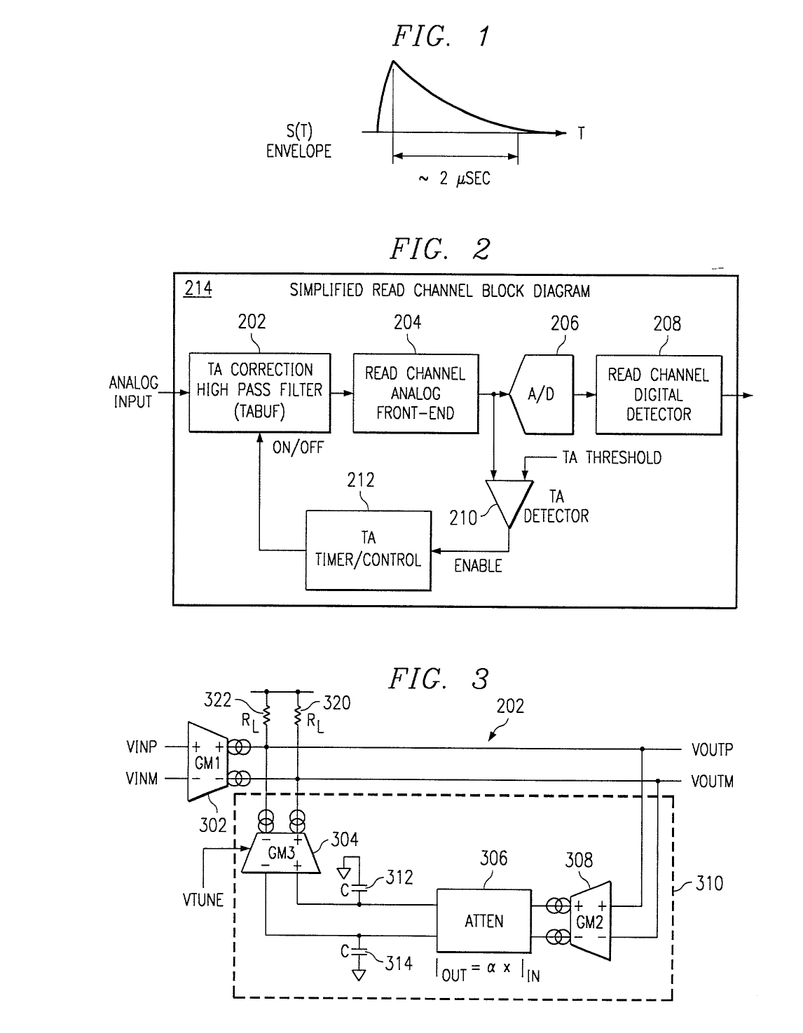

FIG. 2 illustrates a block diagram of the invention.

A TA compensation high-pass filter circuit 202 is connected to a read channel analog front end 204. The read channel analog front end 204 is connected at its output to a A/D converter 206. Additionally, the output from the read channel analog front end 204 is connected to a TA detector 210. The output of the A/D converter 206 is connected to a read channel digital detector 208. Input to the TA detector 210 is a TA threshold signal to be compared with the output signal of the read channel analog front end 204. When the TA detector 210 detects a TA event, evidenced by the output signal from the read channel analog front end 204 which exceeds the TA threshold signal, an enable signal is output from the TA detector 210 and is input to the TA timer/control circuit 212. The TA timer/control circuit controls the TA compensation high-pass filter circuit by timing the duration of the activation of the TA correction high-pass filter 202. In accordance with the output signal from the TA timer/control circuit 212, the TA correction high-pass filter circuit 202 is turned appropriately ON or OFF.

FIG. 3 illustrates a block diagram of the present invention. Differential inputs V_{INP} and V_{INM} are input to transconductance circuit 302. Transconductance circuit 302 is connected to resistor 320 and resistor 322. Output from transconductance circuit 302 is differential output signals V_{OUTP} and V_{OUTM}. These signals V_{OUTP} and V_{OUTM} are input to transconductance circuit 308. The output signals of transconductance circuit 308 are input to attenuator circuit 306. The attenuator circuit 306 has a variable gain to attenuate the input current I_{IN} from transconductance circuit 308 by alpha times the output current, which is output from attenuator circuit 306. Alpha can vary from zero to one. The output signal from the attenuation circuit 306 is current I_{OUT}, which is input to capacitor 312 and capacitor 314. These capacitors 312 and 314 are used to integrate the current and form a voltage V_{OUTP} and V_{OUTM}. The voltage is input to transconductance circuit 304 which receives a tuning voltage V_{TUNE}. The output of transconductance circuit 304 is connected to the output of transconductance circuit 302.

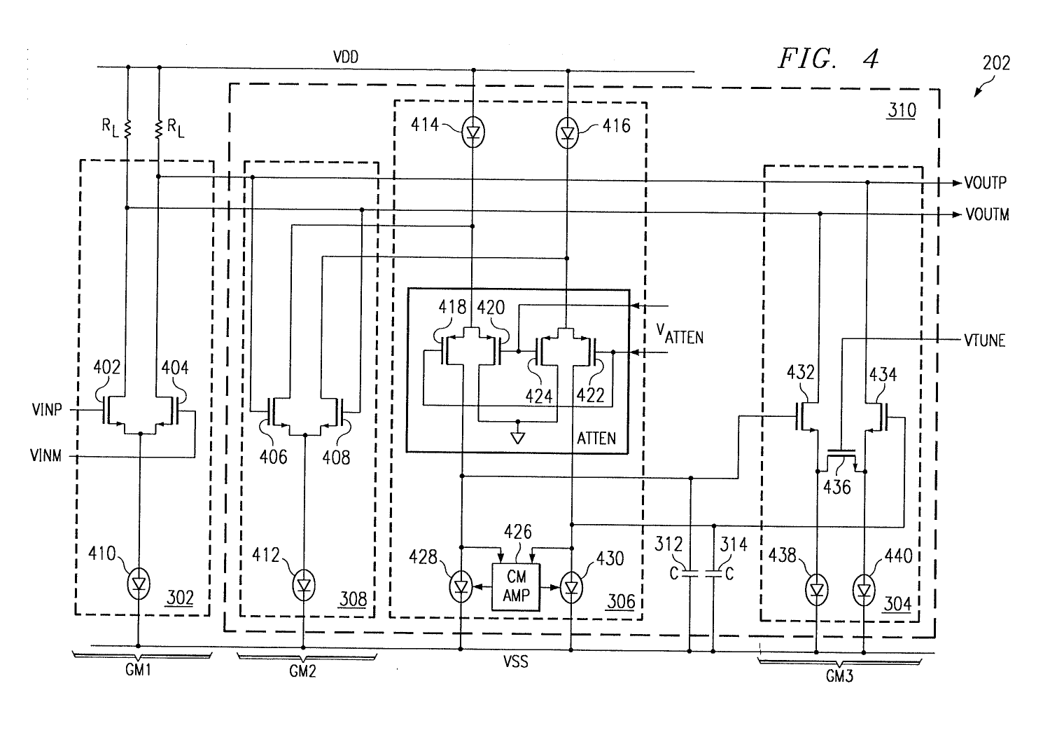

FIG. 4 illustrates more details of the circuit of FIG. 3. More particularly, the transconductance circuit 302 includes a current generator circuit 410 to generate a current through NFET 402 and NFET 404. The sources of NFET 402 and NFET 404 are connected together and are connected to the current source 410. The gate of NFET 402 is connected to receive voltage V_{INP}, and the gate of NFET 404 is connected to receive voltage V_{INM}. The drain of NFET 402 is connected to resistor R_{L}, and the drain of NFET 404 is connected to another resistor R_{L}. The drains of NFET 404 and NFET 402 are connected to output signal V_{OUTP} and voltage V_{OUTM}, respectively.

Transconductance circuit 308 includes a current source 412 and two NFET transistors 406 and 408. The sources of NFETs 406 and 408 are connected together and are connected to current source 412. The drain of NFET 406 is connected to attenuation circuit 306. Additionally, the drain of NFET 408 is also connected to the attenuation circuit 306. The gate of NFET 406 is connected to the drain of NFET 404 and to a terminal of the output voltage V_{OUTP}. In a similar fashion, the gate of NFET 408 is connected to the drain of NFET 402 and to the output voltage V_{OUTM}. The attenuation circuit 306 includes two current sources, 416 and 414. These current sources are connected to voltage V_{DD}. The output of current source 414 is connected to the source of PFET 418, the drain of NFET 406, and the source of PFET 420. The output of current source 416 is connected to the source of PFET 424, the drain of NFET 408, and additionally to the source of PFET 422. The sources of PFET 418 and PFET 420 are connected together. In a similar fashion, the sources of PFET 424 and PFET 422 are connected together. The gate of PFET 418 is connected to the gate of PFET 422. These gates of PFETs 418 and 422 are driven by the voltage negative terminal to receive voltage V_{ATTEN}. Likewise, the gates of PFET 420 and PFET 424 are connected together and are connected to receive the plus voltage of V_{ATTEN}. The drain of PFET 418 is connected to the current source 428 and to the common mode CM amplifier 426 to set the nominal voltage for the attenuator output driving capacitors 312 and 314. Additionally, the drain of PFET 422 is connected to current source 430 and to CM amp 426. The output of CM amp 426 is connected to control the current sources 428 and 430, respectively. Capacitor 312 is connected between the drain of PFET 418 and the current source 428 and the gate of NFET 432. Additionally, the capacitor 314 is connected to the drain of PFET 422 and the current source 430 and connected to the gate of NFET 434. Both capacitors 312 and 314 are connected to ground and the drains of PFETs 420 and 424 are tied to ground.

Transconductance element 304 includes two current sources, namely current source 438 and current source 440. Additionally, transconductance circuit 304 includes NFET 432, NFET 434 and NFET 436. The drain of NFET 432 is connected to the terminal of the output voltage V_{OUTM}. The drain of NFET 434 is connected to the terminal of the output voltage V_{OUTP}.

During normal operation, the high-pass filter is switched off so that the high-pass filter circuit 202 has a frequency response of unity refer to FIG. 2. This is accomplished by setting α=0 in the ATTEN circuit 306 refer to FIG. 3. When the TA event is detected, for example by the use of a slicer within TA detector 210 refer to FIG. 2, a timer is activated for the time period of the TA event. When the TA event is detected, the high-pass filter 202 is activated by switching the gain of the ATTEN block to one (α=1). This closes the feedback loop including transconductance circuit 308, the transconductance 304, and the attenuation circuit 306 which has a frequency response defined by equation 2 with a high pass pole given by equation 1.

$$p = \frac{α G {m}_{2} ( G {m}_{3} \times R L )}{C} , {A}_{V} = G {m}_{1} R L \qquad ( 1 )$$

$$H ( s ) = \frac{{A}_{V} ( \frac{s}{p} )}{1 + ( \frac{s}{p} )} \qquad ( 2 )$$

The pole p, as illustrated above, determines how rapidly the DC offset is driven to zero. Setting this pole frequency too high removes low frequency signal information and can degrade the BER. Thus, the high-pass pole is set at the maximum value that will not degrade the BER, and this value is proportional to the data rate.

The present invention is able to track the data rate by tuning transconductance 304 in FIG. 2 so that it is proportional to the data rate clock. This is achieved by use of the tuning signal V_{TUNE}. This results in optimum DC offset suppression over a wide range of data rates corresponding to READ back signals distributed from the outer circumference of the magnetic disk (OD) to the inner circumference of the magnetic disk (ID). A separate bandwidth tuning circuit (not shown) generates the tuning voltage V_{TUNE} that causes the transconductance circuit 304 to track this data rate. The characteristics of V_{TUNE} corresponding to the data transfer rate are illustrated is FIG. 6.

Another important feature of the present invention is that switching from the activation after a thermal asperity event back to normal operation is gradual. It is important that the high-pass filter pole frequency exhibit a gradual transition from the TA event to the OFF mode. This is done to minimize amplitude and phase disturbances in the read back signal, generated by the read channel, which can degrade BER due to loss of timing recovery synchronization (i.e., loss of lock). This gradual transition is accomplished by controlling the ATTEN circuit so that the gain (α) transitions from unity to zero with a slow exponentially decaying response. Other responses are possible. Additionally, the high-pass filter 202 in FIG. 2 is engaged during the auto-zero mode so that the internal DC offset, which is the result of device mismatching, at the output of the high-frequency filter 202 output is reduced. This ensures that there is no shift in the corrected DC offset going from a normal mode to a TA suppression mode.

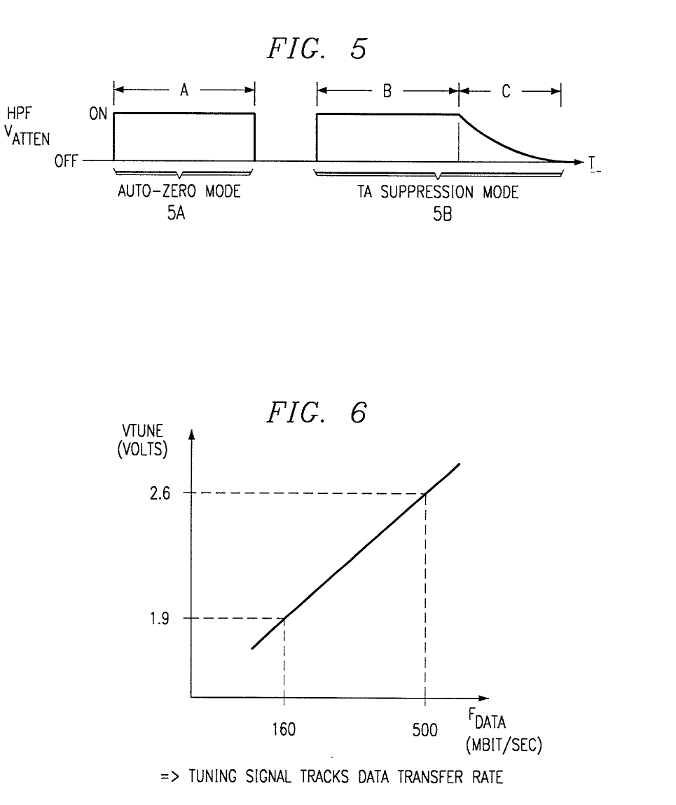

The waveform input to the ATTEN circuit is illustrated in FIG. 5. FIG. 5a illustrates the voltage V_{ATTEN}, applied to the ATTEN circuit 306, for auto-zero mode, and FIG. 5b illustrates the voltage V_{ATTEN}, applied to the ATTEN circuit 306, for a thermal asperity event. Typically, the time a=50-100 nsec, the time b=1 μs-2μs, and the time c=1 μs is as shown. If there is an abrupt change in the pole, a phase delay results in a shift of data, and the shift can be significant enough that the timing recovery circuit loses data and invariably reduces the error rate of the channel. Typically, the auto cycle has a length of 50 to 100 nanoseconds. In operation, for example during an auto cycle mode, the voltage V_{ATTEN} in FIG. 4 goes from a logical 0 to a logical 1 state. Under these conditions, PFET 420 and PFET 424 are OFF with PFET 418 and PFET 422 ON, providing two conducting paths from current source 414 through PFET 418 and current source 416 through PFET 422, respectively, to current source 428 and current source 430. Additionally, the currents from NFET 406 and NFET 408 flow, respectively, through PFET 418 and PFET 422. This current is received by capacitor 312 and capacitor 314, respectively, due to their connection to the drain of PFET 418 and the drain of PFET 422, respectively. A bias voltage forms on each of these capacitors, namely capacitor 312 and capacitor 314. This bias voltage in turn operates NFET 432 and NFET 434, respectively. The bias voltage on capacitor 312 operates NFET 432, and the bias voltage on capacitor 314 operates NFET 434. As a consequence, NFET 432 and NFET 434 are operated independently. This bias voltage applied to the gate of NFET 432 and NFET 434, respectively, affects the amount of current from drain to source of NFET 432 and NFET 434, respectively. Thus, the voltage V_{OUTP} and voltage V_{OUTM} is consequently affected by the amount of voltage on the gate of NFET 432 and the gate of NFET 434, respectively. For example, the more bias voltage that is applied to the gate of NFET 432 through capacitor 312, allowing more current to flow through the drain to source of NFET 432, lowers the voltage of V_{OUTM} since the additional current flow drags voltage V_{OUTM} to ground. Likewise, the amount of current that flows through NFET 434, in accordance with the bias voltage applied to the gate of NFET 434, based on the voltage on capacitor 314, controls the voltage V_{OUTP} by dragging the voltage V_{OUTP} to zero. When the signal V_{ATTEN} abruptly shuts off, as illustrated in FIG. 5a, PFETs 418 and 422 turn OFF, and PFETs 420 and 424 turn ON, shunting the current from current source 416 through the source to drain of PFET 424 to ground. Likewise, the current from current source 414 is shunted through PFET 420 to ground. The proper offset or bias voltage now has accumulated on capacitor 312 and capacitor 314 such that NFET 432 and NFET 434 are properly adjusted to balance the offset from voltage V_{OUTP} and voltage V_{OUTM}. The bias voltage on capacitor 312 and capacitor 314 remains on the respective capacitors. During a thermal asperity event, as illustrated in FIG. 5b, V_{ATTEN} again abruptly changes from 0 to 1 and remains there for a period determined by time period b. The operation is the same as described above, and the offset associated with the thermal asperity event is placed on capacitor 312 and capacitor 314, and these capacitors control NFET 432 and NFET 434 to adjust the voltage V_{OUTP} and V_{OUTM}. However, after the thermal asperity event is over, the signal V_{ATTEN} remains at a logical 1 level. After time period b, the voltage V_{ATTEN} begins to decay in accordance, for example, along the slope illustrated by FIG. 5b. This occurs for time period c. During this time, PFETs 418 and 422 are gradually shut down, and, in the same fashion, PFETs 420 and 424 begin to conduct. On a mathematical level, as a result of this operation, it can be seen from equation 1 that the pole moves from nominal to zero and, consequently, no data is lost by the read channel as a result of the gradual movement of the pole. The voltage V_{TUNE} which drives the gate of NFET 436 controls the output drain currents from NFET 432 and NFET 434 by controlling the effective resistance of NFET 436 which operates in the “triode” mode of operation meaning that NFET 436 behaves as a voltage controlled resistor. As the voltage V_{TUNE} increases, the effective resistance of NFET 436 decreases, thus increasing the output drain currents from NFET 432 and NFET 434 for a given bias voltage at the respective gates of NFETs 432 and 434. As the voltage V_{TUNE} decreases, the effective resistance of NFET 436 increases, thus decreasing the output drain currents from NFET 432 and NFET 434 for a given bias voltage at the respective gates of NFETs 432 and 434. As V_{TUNE} approaches ground potential, the effective resistance of NFET 436 approaches an infinite value thus disconnecting the sources of NFETS 432 and 434 causing the output drain currents from NFETs 432 and 434 to approach zero. The high-pass filter 202 is slaved to the data rate for optimum thermal asperity suppression response with respect to the data rate. This allows faster symbol error recovery and, hence, betters BER. Additionally, the high-pass filter has a corrected DC offset for normal operation and for thermal asperity suppression operation. Consequently, the DC error is correct for both types of operation.

The FETs of the above circuit are interchangeable with p and n devices.

1. An offset correction circuit to correct DC offset in accordance with a data rate, comprising:
a detection circuit to detect a thermal asperity signal; and
a filter circuit to respond to said thermal asperity signal in accordance with said data rate.

2. An offset correction circuit, as in claim 1, wherein said filter circuit affects said DC offset in accordance with said data rate.

3. An offset correction circuit, as in claim 1, wherein said filter circuit is a transconductance circuit.

4. An offset correction circuit, as in claim 3, wherein said transconductance circuit shunts current in accordance with said data rate.

5. An offset correction circuit, as in claim 3, wherein said transconductance circuit includes a FET to shunt current in accordance with said data rate.

6. A disk drive system for reading and writing information on a disk, comprising:
a head to read/write information on said disk;
a preamplifier to amplify said information; and
a read channel to process said amplified information, said read channel including:
an offset correct circuit to correct DC offset in accordance with a data rate, said offset correction circuit including:
a detection circuit to detect a thermal asperity signal; and
a filter circuit to respond to said thermal asperity signal in accordance with said data rate.

7. A disk drive system, as in claim 6, wherein said filter circuit affects said DC offset in accordance with said data rate.

8. A disk drive system, as in claim 6, wherein said filter circuit is a transconductance circuit.

9. A disk drive system, as in claim 8, wherein aid transconductance circuit shunts current in accordance with said data rate.

10. A disk drive system, as in claim 8, wherein said transconductance circuit includes a FET to shunt current in accordance with said data rate.
